(19) United States
(12) Patent Application Publication
(10) Pub. No.: US 2002/0105410 A1
(43) Pub. Date: Aug. 8, 2002

(54) Means, apparatus, and method of security and convenience through voluntary disclosure

(76) Inventor: W. Stephen G. Mann, Toronto (CA)

Correspondence Address: W. Stephen G. Mann, Suite 701, 284 Bloor Street West, Toronto, ON, M5S 3B8, CA

(21) Appl. No.: 09/978,233

(22) Filed: Oct. 16, 2001

(30) Foreign Application Priority Data
Oct. 29, 1998 (CA) 2,248,473
Dec. 31, 1998 (CA) 2,256,922
Mar. 15, 1999 (CA) 2,264,973
Jul. 28, 1999 (CA) 2,280,022

(51) Int. Cl. G05B 23/02

(52) U.S. Cl. 340/3.3; 340/5.81

(57) ABSTRACT

Persons such as travellers in an airport are given an opportunity to remove themselves from being under suspicion of terrorism or the like. Persons are provided with one or more opportunities to reveal information about themselves by way of a personal disclosure that would normally be unacceptably invasive if such disclosure were mandatory. The nature of the personal disclosure is such that almost all persons frequently choose to make such a disclosure in their ordinary day-to-day lives, but would be offended if required to make the same disclosure. In one embodiment, persons are given an opportunity to use an airport lounge spa facility with separate showers, saunas, steam rooms, and whirlpool baths, for men and women. Clothing is safely held (and possibly inspected) by locker room attendants while patrons are using the spa. A method of cost management is provided, whereby the reduction in suspicion (by way of the personal disclosure) of the large numbers of people using the spa is translated into a cost savings in terms of underwriting insurance, or the like, whereby this cost savings funds the construction of the voluntary personal disclosure facility. In another embodiment patrons are offered a free medical exam or health diagnostic that includes a personal disclosure, such as undressing, being scanned, or the like. Other embodiments include an opportunity to play a free Virtual Reality (VR) game using VR goggles having a retinal scanner, or an opportunity to play a free video game by pressing a fingerprint scanner to generate a virtual world from a magnified video image of the participant's thumb.

### FIELD OF THE INVENTION

The present invention pertains generally to security systems for processing large numbers of people in which the people are given an opportunity to self-organize into various different risk categories.

### BACKGROUND OF THE INVENTION

Terrorism has become a recent concern, such as suicide hijackers who might use commercial aircraft to deliberately crash into civilian targets. The damage that can be done by a person taking control of a commercial aircraft is immense not just because the kinetic energy of a modern commercial aircraft can be on the order of 2.5 Giga joules, but, that the aircraft might have large quantities of fuel on board, essentially turning it into a life threatening missile.

While metal detectors may be used to detect weapons such as guns and small knives, terrorists will likely find ways to circumvent these measures, especially if they are on a suicide mission.

For example, with the advent of bioterror, the possibilities of smuggling anthrax, or disease onboard an aircraft is not checked by metal detectors. The attacker could even deliberately infect himself or herself with a serious disease, and travel to the target country. In this instance the terrorist carries the disease within his or her body.

Increasing the mandatory screening of passengers simply increases the delay, and at the same time, passengers often feel indignant to mandatory scrutiny.

### SUMMARY OF THE INVENTION

There are many activities and experiences that persons are willing or even eager to undergo by their own free will, but unwilling (and even horrified) to undergo by force. One example of such an experience is sexual intercourse. Persons are horrified at being forced to undergo such an experience to the extent that severe penalties are imposed on the perpetrators of such force. It is not the activity itself (e.g. sexual intercourse) that is horrible, but, rather, it is the loss of control that the individual experiences over their own personal dignity and personal space.

When the control over someone's personal space is violated, the results are often devastating by way of a psychological trauma that far exceeds the actual physical damage.

Even an unsuccessful or incomplete rape, such as when a victim's clothing is stripped away, but nothing more is done to the victim, can have lasting psychological damage to the victim.

Strip searches often fall into this category, in the sense that they often result in severe psychological damage. Indeed strip searches are often used as part of the torture that political prisoners are subjected to.

Mandatory strip searches at airports are often the cause of major lawsuits in the millions of dollars. However, the same people filing such lawsuits have most likely, at some time in their life, voluntarily undressed in the presence of other people. Communal showers are quite common in athletic facilities, health clubs, and municipal swimming baths. Moreover, many people are willing to pay to use a facility where they are required to undress in the presence of others. For example, while using a luxury spa facility having steam rooms, saunas, whirlpool baths, and the like, users voluntarily remove their clothing.

A person may also be willing to undress in order to undergo a medical examination. The subject of such an examination may also be willing to undergo blood tests, and other invasive tests that reveal personal information and confirm the absence of a disease. Being free of disease and being willing to prove that one is free of disease (or at least being willing to submit to screening) is of great value to society as a whole. Thus, by willingly making a bodily information, disclosure, the subject has bestowed a benefit upon society. Therefore, a method of doing business in such disclosure may include a method of allowing the subject (the disclosee) to benefit, at least partially, from making the disclosure. For example, the costs of the medical examination could be reduced or the medical examination could even be provided free of cost, in return for the benefits derived from knowing that the subject is disease free. Thus a passenger willing to submit to a quick and efficient medical screening exam could be provided with that exam free of cost, and could also be granted expedited boarding of the aircraft. Thus those willing to undergo such an exam could, for example, bypass the lineup at Customs and Immigration, or could receive non-suspiciousness index (NSI) points for the disclosure. Those formerly suspected of possibly carrying disease into a country could therefore voluntarily remove themselves from such suspicion, or at least reduce their level of suspicion, by submitting to a bodily information disclosure coupled to a suspicion decrementer.

A person undergoing a medical exam will often undress to do so. If a person had explosives taped to his or her body, or was carrying a concealed handgun, or other contraband, it is less likely that such a person would take advantage of an offer for a free medical exam. Thus offering a free medical exam, a free checkup, or even a free body scan, could allow persons to self-organize into a low risk category and an unknown-risk category. If there was a free medical exam booth, and a person could skip the long lineup, or at the very least, hold their place in line but get a free medical exam during the time they would otherwise spend waiting in line, at least some persons would take advantage of such a program. The program could also be offered at very minimal cost, by using an automated “digitizing” scanning booth. At the same time as a person is examined, their clothing could be scanned or inspected. It is not necessary to examine the clothing of every volunteer subject, but only that there be the possibility that the clothing might be inspected. This possibility would keep terrorists from deciding to be subjects.

When participating in activities, such as the use of a municipal swimming bath, that involve the removal of clothing, users get to maintain control over their clothing through the use of personal locks that the users bring to a locker room facility. However, in other situations, users are quite willing to lock their clothes into a locker that can obviously be opened by an attendent. For example, a sign in the men's locker room of the Alumni Pool at the Massachusetts Institute of Technology (MIT) reads “All non MIT locks will be cut off”. Students, staff, and faculty willingly strip naked in view of others, and then lock their clothes into lockers that have the potential to be inspected. In a sense these persons are willingly leaving themselves vulnerable to an inspection of their clothing and personal effects in their absence (e.g. while they are using the pool).

MIT like many of the so-called “ivy league” colleges has a mandatory swim requirement in which a swim test must be completed in order to receive a graduation diploma. Although the swim test is trivial in difficulty, it does require the following:

undressing in the presence of others;

showering while completely naked, in the presence of others (a sign in the MIT alumni pool shower room reads “A thorough soap shower, without suit, must be taken prior to entering pool area”);

being supervised while in a state of partial undress (e.g. wearing only “proper bathing attire”) by a person administrating the swim test;

showering again;

getting dressed in the presence of others.

Ordinarily the swim test is administred over a two day period for most of the incoming freshmen, such that the above undressing and being naked in the presence of others takes place in a very crowded environment.

When the applicant raised a privacy concern of the above procedure with MIT's student privacy representative (Amy Bruckman), the representative dismissed the concern as unfounded.

It is possible that an organization such as the American Civil Liberties Union (ACLU) could address mandatory swim tests, in the manner in which mandatory showers in high school gym classes had been addressed by the ACLU:

Students who dreaded showering at school got a lift two years ago after the American Civil Liberties Union threatened to file a lawsuit in Federal court over a mandatory shower policy in Hollidaysburg, Pennsylvania, the Times said. “Unless a student is drawing flies,” said David Millstein, the lawyer in the case, who represented a shy, overweight girl who felt humiliated in the showers, “It's none of the school's business.” The school district dropped its policy. But in the meantime, Mr. Millstein was deluged with calls and letters of support from people who remembered their own feelings of shame and embarrassment in the public showers. “In 25 years of doing ACLU work—cases on prayer in the school, you name it I had never had any response like this,” he said.

Referenced New York Times, Jul. 25, 1998, cached in http://wearcam. org/envirotech/aclu_gym_showers2.htm

Thus it appears that mandatory stripdown requirements of any sort are likely to come under attack, and are not likely to be well received. Thus mandatory stripdown situations appear to be declining.

However, voluntary stripdowns appear to be on the rise, with growing numbers of persons joining athletic clubs, using communal spa facilities, and with increased body acceptance. While previously bombarded with television and advertising images of perfect bodies, we are now beginning to see a more typical “person next door” kind of look, that suggests an increased degree of body acceptance among a wider variety of members of the population. The proliferation of waterparks and leisure centers suggests that in the near future, ordinary people will feel comfortable in a bathing suit, while it is likely that terrorists trying to hide guns and knives in their loose (“baggy”) gang-style clothing will likely feel a little out of place in a waterpark, leisure center, or spa, especially if clothing storage means such as lockers have a key escrow feature.

Many establishments reserve the right to inspect lockers, and., in that setting, users are still willing to use these facilities. Some waterparks, such as “Schwaben Quellen” (a member of European Waterparks Association) in Stuttgart require users to be completely naked except for a wristband which is a transponder that trackes the user's whereabouts throughout the park.

Users do not appear to object to the idea of being required to be completely naked to use the spa facility, nor do they object to the idea of being required to wear a tracking device. They also do not object to the fact that their clothes are in a space that could be opened by waterpark officials without their knowledge.

Moreover, users pay a fairly high user fee to use these facilities, and it is considered a luxury to have the privilege to strip naked and splash around in various baths, or the like. Many fine spa facilities have a locker room attendant who handles and keeps the clothing of spa visitors in a clothing check area. The tradition of having a human attendant hold onto the clothing and personal effects of bathers dates back to Roman times., and is often seen as a feature of a very upscale spa facility.

To prevent the theft of clothing by staff, or by bath thieves, video surveillance is sometimes used. For example, the lockers at Blizzard Beach (a large waterpark in Florida) are overlooked by large video surveillance cameras. No effort has been made to hide the cameras, and it appears that such cameras make waterpark uses feel safe. Additional surveillance cameras throughout the facility capture images of bathers in a state of partial undress (e.g. wearing only a bathing suit) which does not appear to upset the bathers. Bathers continue to actually pay money for the privilege of stripping down and splashing around in the facility while being videotaped by security staff.

It is doubtful that a terrorist with weapons and explosives taped to his or her body would use a waterpark, spa facility, or the like.

Therefore, providing an opportunity to use some form of waterpark, spa, or other voluntary stripdown facility at a high security area such as an airport, would split the user population into two groups:

personal disclosure participants who are very unlikely to be terrorists;

personal disclosure nonparticipants who may or may not be terrorists.

Those in the “personal disclosure nonparticipants” category are not necessarily terrorists. They might, for example, be “cyborgs” wearing a medical or prosthetic apparatus, wearable computer, or the like, or they could simply be persons who are adverse to getting wet. For example, a person who has spent a great deal of effort in terms of hair styling and makeup might not wish to get wet.

Nonparticipants numbering N, together with M participants (men and women) will comprise a total population of M+N persons entering a secure area. The fraction M/(M+N) will comprise persons having a reduced need for suspicion and scrutiny because it is likely that this fraction of the population will represent a reduced risk.

Risk costs. Processing a high number of high risk persons costs more, because additional security staff is required, further screening is needed, and there may be delays in lineup which cause further indirect costs. Such indirect costs include reputation costs, and goodwill costs, in terms of user satisfaction.

The cost of reducing the security risk of a nonparticipant down to the same level as a participant can be quite high. For example, requiring a nonparticipant to undergo a strip search may give rise to an expensive lawsuit, and to a large delay. For example, suppose that participants have willingly stripped down, and are relaxing in a spa. Because the spa is an enjoyable experience that they wish to participate in, they strip down willingly, quickly, and without any problems. Nonparticipants selected for a strip search will present delays (undressing slowly and being uncooperative), and further costs later (lawsuits later on, bad feelings, bad publicity, etc.).

Obviously not every nonparticipant will need to be strip searched, but consider some probability of strip search p for the total population. Without the use of the spa facility we would have p(M+N) strip searches to perform, at a cost of cp(M+N) where c is the cost per strip search. The cost c includes indirect costs, such as the cost of bad publicity, the cost of defending lawsuits, and other costs, as well as the actual cost of hiring staff to carry out the strip searches and to perform the screening necessary to decide who to strip search. In times of crisis consequence management, or in times of heightened security, it is quite possible that:

cp(M+N)>sM+cpN (1)

or equivalently:

cpM>sM (2)

where s is the per-person cost of running the spa or other voluntary personal disclosure facility. In situations where Equation 1 is true, the costs of providing a spa for M people is less than the costs of providing strip searches for the fraction p of that same number of people. The cost savings, sM−cpM can be given back to the participants, in the form of subsidizing the spa treatments.

In one embodiment a spa facility adjacent to or near to the airport is run by a private organization working together with the customs service, government, customs officials, and airlines, etc. Costs of spa treatments are subsidized by the savings to the airlines, and to the government, etc., in terms of reduction in costs resulting from the personal disclosures made by those using the spa.

Spa users are pampered, and all the details are taken care of for them. Their luggage, and personal effects may be carefully and skillfully handled for them, and they may be taken directly onto the plane, in an express shuttle, so that they can board before any of the other passengers. Their carry on bags may be loaded onto the plane for them, so that they experience a nice service gesture in exchange for allowing a search of their carry on bags to take place while they are relaxing in the spa. In effect, they are pampered and cared for in return for submitting ot search.

Participants receive a non-removable wristband as a status symbol to indicate their special status, and to track them while they are in a state of being partially or wholly undressed. Their ticket information, seat number, etc., with resect to the wristband, appears thereon, is encoded therein, or the like.

It is quite possible that the cost savings are, or become, significant, in which case the use of the spa could actually be offered free of charge. Perhaps then, it would make sense to build the spa directly into the airport. A good place to build it would be a central place, such as where persons enter to clear customs. In this way, the voluntary disclosures made by participants could speed the participants through customs, as well as through airport security.

The wristbands can encode and keep track of what facilities are used by the participant. As the participant uses more and more of the facilities, a “suspiciousness index” can be decremented. For example, suppose a participant strips naked, puts his clothes into a metal basket and hands the basked together with his luggage to a locker room attendant. That act alone reduces his suspiciousness index. The attendant can also gauge, based on personal experience, the demeanour and actions of the participant and award a certain number of points to the participant based on the facial expressions, and behaviour of the participant. Preferably the locker room attendant is a skilled customs official with many years experience in “reading” facial expressions. Stripped of clothing, eyeglasses, wearable computers, and other visual detritus, the participant is visible to the attendant, in a manner in which the attendant can see the true nature of the subject, the naked truth, and can make this truth of record.

This record can be made by way of a wristband issuing station, in which, at this point, while the participant is standing naked at the clothing check-in area, the attendant issues a wristband. The act of entering a suspiciousness coefficient can be made covert by simply having the attendant hand the participant a wristband selected from several piles of wristbands, each pile having a certain suspiciousness coefficient already associated with it.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 depicts an a disclosure pavillion sending data to a remote facility garden.

FIG. 2 depicts a system with airport spa facility.

FIG. 3 shows a wristband for use in an airport spa.

FIG. 4 depicts an examination facility for allowing persons suspected of carrying disease to reduce their suspicion of being disease carrying or verminous persons.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

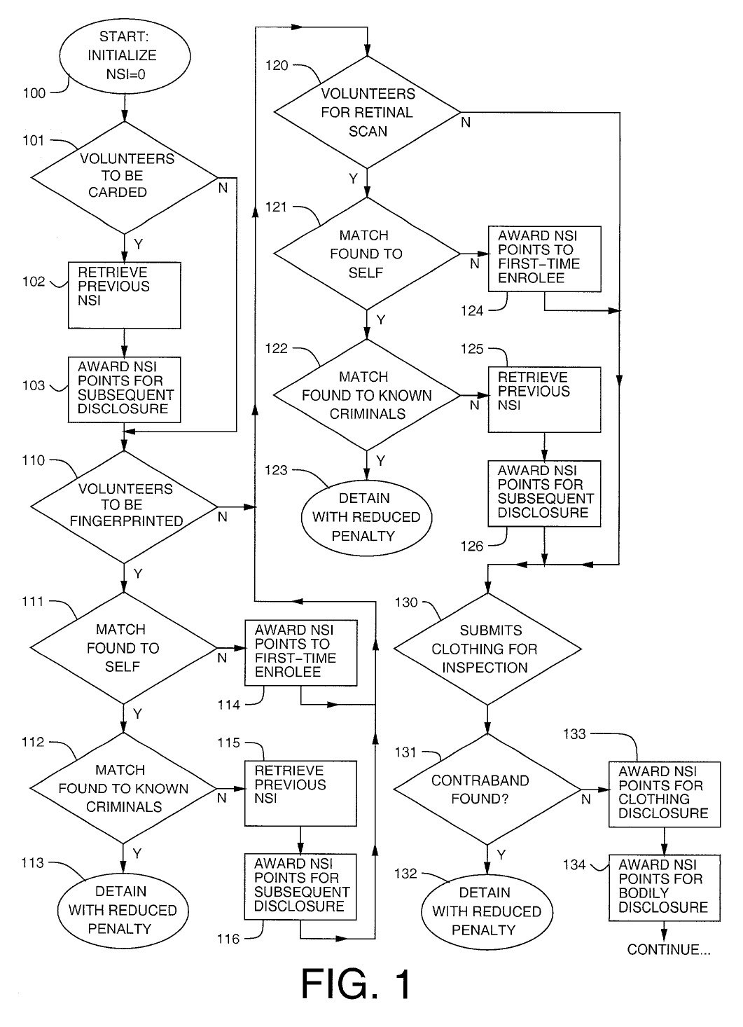

FIG. 1 is a diagram showing the operation of a disclosure pavillion having various exhibits. Each exhibit allows a person to choose to make a disclosure, if they wish to make such a disclosure. Rather than the specific lineup at an airport, or the like, the facility has a much more free atmosphere, in which persons can enjoy various exhibits in the disclosure pavillion. The exhibits can be visited in any order, and can be visited any number of times, including zero times for some of the exhibits if desired.

The flowchart of FIG. 1 illustrates a particular ordering, which is in no way meant to limit the scope of the invention. An unknown participant who has never participated in any of the exhibits is said to have a Non-Suspiciousness Index (NSI) of zero, e.g. NSI=0. Initially, at the start 100, such a person may choose to insert his or her ID card into a disclosure station. The station might offer free services, such as free Internet access, so that the person just uses their driver's license, or even a credit card, for identification purposes only, in order to “log on” to a computer terminal and to “surf” the world wide web for free. Preferably the participant is videotaped or video captured while doing this activity so that a remote facility garden can associate the name (on the ID card) with a face. The facility garden need not be located right at the disclosure pavillion, and in fact a single facility garden at a remote site, such as in the Far East, can monitor numerous disclosure pavillions.

When the participant volunteers to be carded (e.g. uses an ID card to take advantage of a free service), the participant can receive targeted advertising tailored to their specific profile and interests. Thus at least a portion of the facility garden can be paid for by corporate sponsors who can run the exhibit that might, for example, preferentially direct users to their corporate web sites. A testing unit 101 checks to see if the user has volunteered, and if so, an NSI retriever 102 gets the previous NSI from the facility garden, and an NSI awarder 103 updates the participant's NSI. Now the participant has a higher NSI (e.g. a reduced suspicion), simply because he or she is no longer a stranger.

Various exhibits in the pavillion have pushbuttons that are really also fingerprint scanners. For example, a pinball machine having two flipper buttons that are fingerprint scanners allows a participant to play a free game of pinball, while being fingerprinted many times. A videoorbits image consolidator makes a superresolution image of the subject's fingers over the course of the game. Cameras inside the pinball machine also scan the face of the player, so that the garden can match the print to the face.

An automatcher 111 checks to see if a person is already in the garden; if the garden receives a print that is thus far unknown to it, an awarder 114 awards points to the subject as a first time enrollee.

The public safety value in a person volunteering to be fingerprinted is, at least, in part, returned to the participant, by way of a free game, by way of expedited boarding, or a combination of these. Thus a person waiting to board an airplane can make a choice between, for example, a one hour wait in line, or a half hour game of pinball. Those choosing the half hour game of pinball board faster, and also enjoy the shorter waiting time because they can pass away this shorter time period playing a game of pinball. When a person plays, everyone benefits: the public benefit because the person has undergone a background check; the individual person benefits because at least some of the benefits to the public are reflected back to the individual player. Those who play the game are rewarded with faster boarding of the aircraft.

Unlike traditional background checks, the garden adds a fun element to being fingerprinted. Although such a system could be used to conceal the fingerprinting (e.g. it could operate covertly), rather than conceal this operation, it is preferable that participants know that they are being fingerprinted, but be left with the ability to sustain an at least illusory notion of freewill. Thus rather than merely offer a person a chance to be fingerprinted to board the aircraft sooner, the person is offered a sweeter deal in which the fingerprinting is buried into something that is at least allegedly recreational or fun in some way.

While it is true that a person could be offered a free cup of tea with sugar, as well as expedited boarding, for being fingerprinted, so that the cup of tea would take the role of this deal sweetener, the cup of tea is no more directly attached to the fingerprinting than is faster boarding of the airplane. Thus the pinball game is a deal sweetener that makes the being fingerprinted a concomitant activity.

By making the fingerprinting concomitant to a recreational or leisure activity, the fingerprinting is made less confrontational to the subject.

Moreover, the entire pavillion, that includes fingerprinting, as one possible choice, further makes the situation less confrontational. Thus in addition to sweetening the deal, the invention softens the deal, to make it less confrontational, and less regimented.

Thus it no longer becomes a simple deal like “if you submit to being fingerprinted we will let you board 30 minutes sooner”, or the converse: “if you don't let us fingerprint you, we will make you wait 30 minutes longer and you might miss your flight”.

Instead it becomes a softer deal like “let us get to know you and we'll quite likely get you on your flight sooner and reduce your chances of missing your flight”.

If the automatcher 111 finds that a player is already in the garden, and in particular, if criminals are also in the garden (e.g. if the facility garden has a database of known criminals or terrorist suspects), a crime-matcher 112 checks for criminal match.

If a criminal match is found, the player may be detained by way of detainer 113 such as foot brackets that quickly clamp around the player's feet to detain the player for police questioning. In the rare occurrence of such detention, the penalty is reduced. For example, the player can still continue to play while police arrive, such that the detention is not quite so boring as being hog tied or handcuffed. Additionally further reductions in penalty may be afforded by virtue of the voluntary disclosure that led to the detention.

Since detentions are a rare occurrence, most of the participants are left free to wander around the pavillion and keep feeding information about themselves back to the garden. Those who are known to the garden but are free of criminal matches, are logged in by retriever 115 to their previous NSI rating, and awarder 116 provides them with extra points for their subsequent play.

In no particular order, participants may wander around the pavillion and, for example, play a virtual reality game with goggles that contain a retinal or iris scanner. Those who thus volunteer for a retinal scan with scanner 120 are tested by automatcher 121 and receive points by awarder 124 for allowing the garden to get to know them, if they are previously unknown to the garden. Those who have an automatch as found by automatcher 121 are tested for criminal match by matcher 122 and detained by detainer 123. Detainer 123 may include a head vice comprised of the virtual reality goggles, such that the goggles lock onto the player's head so that he or she cannot get them off. Thus the player is detained by way of the cord connecting the goggles to the game console.

As a reduced penalty for submitting to the voluntary disclosure, the player may be allowed to continue to play a few free games while police are on their way.

Assuming no criminal match in matcher 122, a player's previous NSI is retrieved by retriever 125, and an awarder 126 provides extra points for subsequent disclosure. Other activities in the garden may include waterplay activities, spray games, or water leisure activities such as a hot tub, jacuzzi, or the like.

A participant enters to a locker room 130 to undress and submit clothing to a locker room attendant for storage. Implicit in this submission is a possibility that the locker room attendant may inspect the clothing. Preferably a video surveillance camera ensures that the locker room attendant does not steal items from the clothing. Because there may be jewellery, cash, and other valuables left with the attendant, there is preferably a security system to ensure that the attendant does no steal items from those left for safe keeping.

Preferably there are dual separate tracks in locker room 130 for men and women to undress separately and each submit their personal effects to a separate locker room attendant of the same gender.

Instead of a locker room attendant there may be lockers that have the possibility of scanning clothing, with a scanner 131 and the possibility of detention with detainer 132 in which a participant is detained or locked in the locker room until police arrive, should contraband be found in the clothing.

However, it is expected that contraband will not be found, and that a participant will be awarded NSI points by awarder 133 for submitting to clothing inspection, and NSI points by awarder 134 for submitting to bodily inspection.

Participants are free to use various spa facilities such as steam rooms, saunas, whirlpools, and the like. Participants receive a wristband and are served by an attendant who comes around and offers a free fruit platter, a free beverage, or the like, while asking questions such as “did you pack your bags yourself prior to depositing with us?” and “do you have anything to declare . . . have you been on a farm in the past 14 days . . . ”. In this way, both Customs and Immigration as well as airport security screening are combined with spa relaxation.

Rather than waiting in line to answer these questions, participants simply enjoy a bath while the attendant comes around and asks questions. The attendant wears a computer system to record the answers from the participant. A waterproof wearable computer is used to capture these answers from each participant, while also identifying the participant by face recognition, biometrics, or by way of scanning the wristbands, or a combination thereof.

Participants are informed of their time to board the aircraft, and the attendant ensures that participants who are in the spa do not miss their flights. Although nonparticipants (those outside the spa) could miss their flights because of delays, lineups, and background checks, the attendants ensure that those in the spa are pampered and cared for, and do not miss their flights.

Thus nonterrorists can choose to enjoy a utopian airport lounge in which they obey all orders, relax, and have everything done for them.

Suspicion costs everyone. When a person is suspicious, more checking is needed, and more risk is encountered. Risk costs. Thus when even a small number of people choose to opt for a suspicion reduction, there is a cost savings. The cost of the spa can be covered by this reduction in suspiciousness.

Moreover, terrorism causes longer delays which result in more “air rage”. Air rage is a new epidemic where weary travellers become violent after being delayed in the long lines that are necessary in times of heightened security. However, rather than spending that time in line, where tension runs high, the time can be spent relaxing in a spa, where calming music and the thereputic baths help travellers relax. The reduction in air rage could save airports billions of dollars a year. The invention allows some of this savings to be passed to the users, by providing more calming lounge areas.

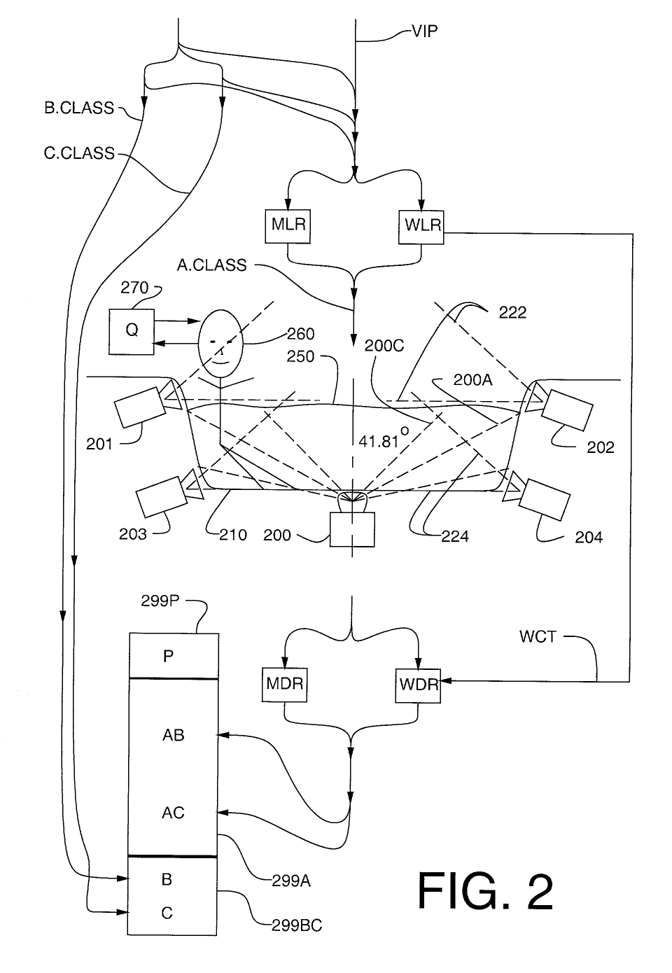

FIG. 2 shows a system for allowing passengers to self organize into three classes, Antiterrorist (A) class, Business (B) class, and Coach (C) class. Incoming passengers VIP are those who have already chosen the spa experience. Passengers B.CLASS and C.CLASS lining up for business and coach class respectively, are informed of the VIP passengers and are given the option of joining the participants in the passenger line VIP.

At any time they are free to enter in a line formed for VIP passengers, and then split off into a Men's Locker Room MLR, and a Women's Locker Room WLR. These passengers emerge each wearing a recyclable bathingsuit which has a barcode or other electronic code number encoded into the bathingsuit so that they can be tracked and pampered by spa facility staff. Passengers emerging from locker rooms MLR and WLR join up as A.CLASS passengers wearing their bathingsuits and ready to enjoy their waiting time soaking in a tub made of acrylic or polycarbonate optics 210.

Bath tubs and shower enclosures are often made of acrylic, or of polycarbonate. In a preferred embodiment the tub is made of smoked polycarbonate, or smoked acrylic, so that it forms optics 210. Such a tub will have a black appearance to a user of the tub, but image sensors 203 and 204 concealed under the tub will be able to see the user of the tub. Additional image sensors 201 and 202 may also be concealed behind the dark transparent bath tub material in such a way that they provide a field of view 222 of the bather above the waterline 250 during typical usage.

The intelligent bath tub has no knobs, or other adjustments, and is therefore much easier to use. The user simply strips down, and sits in the tub. and then the tub fills with water by way of activation of an actuator.

Sensors 201 and 202 also monitor the amount of water in the tub, and as the tub gets close to full, the water flow is gradually reduced. A sophisticated control system is possible without much cost, since the sensors and processors and controllers are already present for security reasons.

In some embodiments, a single image sensor 200 is sufficient to see into the entire tub, as well as up and out of the tub when the water is still, up to and including a critical angle of approximately 41.81 degrees (an angle of approximately 0.73).

Thus the intelligent bath tub serves users of the tub by way of control of an actuator in response to user activity.

The explanation of this tub has assumed that there is only one user, but the invention can also be applied to multi user baths such as whirlpools, jacuzzis, steam rooms, and other bathing environments as may be found in the airport waiting room spa of the invention. For example., a bath can begin to fill when a user sits in the tub, and then jets can massage the user's body. If another user enters the tub, other jets can be activated for that other user. A pattern of jets can operate for optimal user satisfaction, given the distribution of users in the bath.

In a sauna bath, heat flow can be directed in response to the occupants of the sauna, so that the majority of users experience the best sauna bath that the bathroom environment can provide, through intelligent control of air jets, heaters, and ventilation systems.

The optics 210 allows bathers to be visible from the garden, so that computer vision systems in the garden can track bathers by way of the barcodes on their bathingsuits, or other indicia. The bathingsuit barcodes can be invisible to human users, but visible only to the machines, by way of infrared or ultraviolet markings, or by way of other electronic detection means.

Additionally, the computer vision systems in the facility garden can scan for suspicious activity, and scan faces of participants to ensure no suspected terrorists are present.

Moreover, the computer vision systems can have other concomitant uses such as remote lifeguarding, and ensuring safety in the event of any slip-and-fall accidents, as well as keeping recordings of such incidents for insurance purposes.

Preferably the bathing or spa facilities are visible to passengers in B.CLASS and C.CLASS. Thus those in the long lines for B.CLASS and C.CLASS might consider spending the time that they would be just simply standing in line, instead soaking in the spa.

While bathers are relaxing in the bath, attendants can use a questioner 270 to ask questions from the users. Thus user 260 can soak in the bath and relax while answering questions like “anything to declare?”.

The questioner 270 can be a videophone to a customs official, or a wearable computer attached to a spa attendant and possibly linked remotely to a Customs and Immigration office, or for recording data for being queued and reviewed by a customs official or security official.

By working together, Customs, the police and security staff, the airlines, and the spa can reduce terrorism. Government and industry can work together to pamper passengers while they merely relax and obey.

Passengers are helpless to produce their own tickets because they are in the bath, so as a result they are pampered and assisted in various ways. Their clothing, jewellery, and personal effects are moved forward along clothing transfer path WCT, so that these items arrive into the respective Men's Dressing Room MDR and Women's Dressing Room WDR. Thus by the time the passengers are prompted by staff to head to the MDR and WDR their clothes have been potentially examined or spot-checked and are ready.

An airplane is sectioned off into three compartments, a pilot's cockpit 299P, a class A section 299A, and a class BC section 299BC. A pilot P is protected by a barrier from class A passengers in section 299A. A very strong and impermeable barrier divides class B and class C from the pilot and class A. Class A boards at the front of the plane with the pilot, because we know that class A is free of terrorists.

Class B and C board behind a heavy re-enforced barrier that could contain an explosion. Preferably the barrier is behind the wings, so that in the event of an explosion in section 299BC the aircraft would remain operational.

Optionally, Class A may be split into two classes: Antiterrorist Business class AB and Antiterrorist Coach class AC. Class AB can thus board separate from class AC so that class distinction is possible within the Class A passengers.

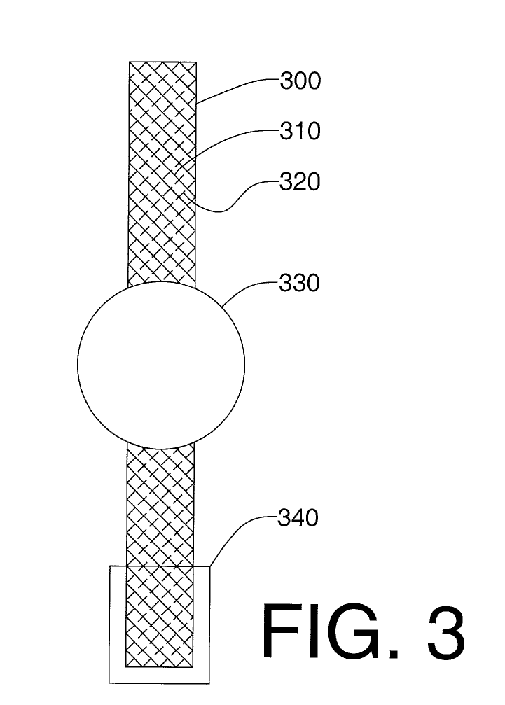

FIG. 3 shows a wristband that can be worn in an airport spa, airport lounge, or other area such as a place where NSI points can be incremented or decremented. A fastener 340 brings band 300 together. Band 300 has outside wiring 310 and inside wiring 320. The inside wiring 320 is shown as hidden lines (dotted lines). The wiring is preferably in a lattice so that tampering with the wristband (e.g. trying to swap with someone else) would break at least some wires and de-activate the authentication loaded into core 330.

Core 330 is connected to the wiring, and when the fastener 340 joins to the other side of band 300, core 330 can be programmed with this joining information. The joining will connect essentially random connections of the wiring, so that core 330 can be programmed with a key that is responsive to the essentially random connections. Opening the wristband will open these random connections. Re-closing the wristband (e.g. on someone else's wrist) will cause different random connections to be made, so that the key will be lost.

The wristband can be re-used, but it must be re-programmed once it is disconnected and reconnected.

An important aspect of the wristband is the use of sloppy connections that connect different sets of wires each time it is closed. A tolerance on the flex and differentness of the wires may also be incorporated so that a small amount of wear is acceptable but a larger difference in connectivity will be flagged as a change.

Additionally, core 330 is programmed so that any disconnection will clear the key.

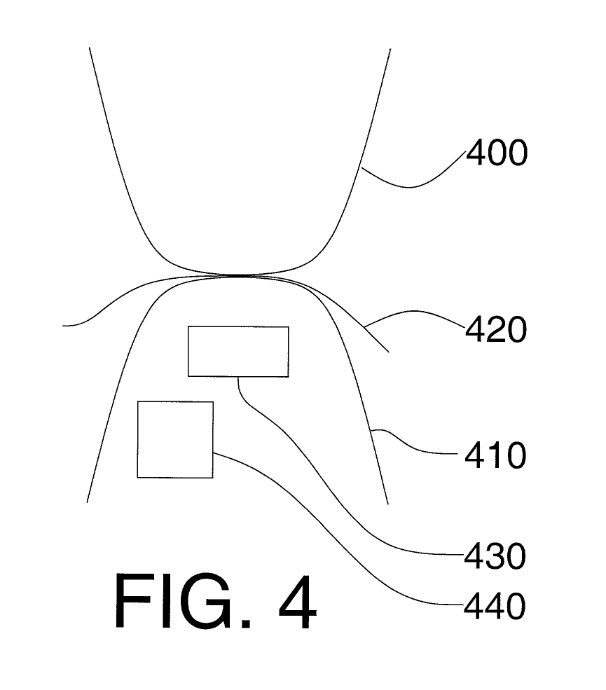

FIG. 4 shows an examination surface for use in an examination booth. The surface is curved, preferably saddle shaped with downward pointing sides 410 and a stirrup 440 allowing a subject to be seated onto the surface. Stirrup 440 has a footprint scanner to scan the barefoot pattern of a subject and thus contribute more personal information to the garden. Additionally an interface panel 430 includes a fingerprint scanner that the user can press on, by pressing different “buttons” that are actually fingerprint scanners. Each button is labelled, allowing the user to select different tests.

The surface has upward pointing front and back 400, so that the subject can sit with legs on either side, and be examined by the contoured surface. The surface is preferably made of vitreous china or other glasslike material that is partially transparent. Sensors such as video cameras and infrared scanners behind the partially transparent surface material capture information about the subject that determine if the subject is disease carrying and also provide information about identifying aspects of the subject such as identifying scars, marks, and tattoos on the subject's body. In this way, the apparatus can also be used as a police booking station to capture information about a suspect's body.

Preferably cameras or other instruments scan the subject's body in a first scanning stage to automatically determine the location of any identifying scars, marks, tattoos, or the like, and then a second scanning stage captures close-up images of these identifying features of the subject's body.

The subject may volunteer to provide various samples for a free medical examination. A blood tester is included in interface panel 430 so that the subject an leave a blood sample. The surface is also curved in such a manner that it can carry away bodily wastes, so that the subject can leave behind waste matter for collection into a waste analysis bowl. The subject can defecate to surface 420 leaving a sample for medical analysis or the subjects can provide a urine sample, sperm sample, saliva sample, or the like, or other samples such as skin and hair samples for DNA analysis.

Appropriate openings in the vitreous material receive samples. Sensors such as video capture devices document the collection of the samples, and provide additional data to the remote facility garden for possible later analysis by medical experts and epidemiologists.

Such a disclosure booth can be used to allow persons to clear Customs and Immigration, or to clear security checkpoints quickly. For example, passengers can arrive late, e.g. perhaps only ten minutes before and international flight departs, and still board the flight through voluntary disclosure. The speed of boarding is limited only only by how fast the patient can undress himself or herself and get inspected. Because this procedure is voluntary, it allows persons to choose disclosure as a way of saving everyone, including themselves, time and effort.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

From the foregoing description, it will thus be evident that the present invention provides a design for a voluntary disclosure means, apparatus, or method of providing enhanced safety or security in proportion to the decrease in suspiciousness of the disclosee, along with means., apparatus, or method of allowing the disclosee to share in the benefits of his or her disclosure. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

The embodiments of the invention in which I claim an exclusive property or privilege are defined as follows:

What I claim as my invention is:

1. A voluntary disclosure system for allowing users to place themselves under reduced suspicion by volunteering to disclose personal information, said voluntary disclosure system comprising:
a voluntary disclosure fixture for being voluntarily used by some of said users;
a user-specific non-suspiciousness accumulator for being initialized prior to usage of said fixture by each user of said fixture;
recording or observing means for recording or observing personal information of at least a portion of users of said fixture, during usage of said fixture,
said non-suspiciousness accumulator being incremented through usage of said fixture.

2. The voluntary disclosure facility of claim 1 where use of said fixture is for undergoing a medical examination in a medical examination booth, said recording or observing means being for viewing by medical staff at a remote site, or at a later time.

3. The voluntary disclosure facility of claim 1 where use of said fixture is for undergoing a medical examination in a medical examination booth, said medical examination booth including deposit facilities for collection of one or more of: a blood sample; urination sample; defection sample; sperm sample; DNA sample; hair sample; skin scrape sample.

4. The voluntary disclosure facility of claim 3 in which said fixture includes a curved surface made from one of:
smoked polycarbonate:
smoked glass;
partially transparent material,
said fixture having one or more image sensors concealed behind said surface, said surface for seating of one of said users undergoing said medical examination, said surface having one or more openings to receive said sample, said fixture including a processor responsive to an output from said image sensors, said processor automating at least one aspect of a process in undergoing said medical examination.

5. The voluntary disclosure facility of claim 1 in which said fixture includes a curved surface made from one of:
smoked polycarbonate;
smoked glass;
partially transparent material.
said fixture having image sensors concealed behind said surface, said surface for seating of one of said users undergoing said medical examination.

6. The voluntary disclosure facility of claim 1 where use of said fixture requires the removal of at least some clothing, said recording or observing means arranged for recording or observing users of said facility in a state of being not fully clothed.

7. The voluntary disclosure facility of claim 1 further including at least one locker room, in which at least some of said users undress and give their clothes to a locker room attendant for safe keeping, said recording or observing means including a scanner for scanning said clothes.

8. A spa facility incorporating the voluntary disclosure facility of claim 1, in which said fixture is at least one spa fixture from the list of:
a whirlpool bath;
a steam room;
a sauna;
a shower,
said recording or observing means including the inspection of users of said spa fixture by an attendant of said spa facility.

9. A terrorist-reduction cost-sharing airport spa facility incorporating the voluntary disclosure facility of claim 1, in which said fixture is at least one spa fixture from the list of:
a whirlpool bath;
a steam room;
a sauna;
a shower,
said recording or observing means including the inspection of users of said spa fixture by an attendant of said spa facility, said spa facility further including a tracking system for tracking the extent of bodily disclosure of users of said spa facility, and for tracking costs savings arising from suspiciousness reductions associated with said disclosure, said spa facility being provided at reduced or zero cost to users, based on said costs savings.

10. A method for running a voluntary disclosure system for allowing users to place themselves under reduced suspicion by volunteering to disclose personal information, said method comprising the steps of:
offering users the opportunity to use a voluntary disclosure fixture;
keeping, for each potential user, a user-specific non-suspiciousness accumulator, and initializing said non-suspiciousness accumulator prior to usage of said fixture by each user of said fixture;
recording or observing personal information of at least a portion of users of said fixture, during usage of said fixture;
incrementing said non-suspiciousness accumulator in response to usage of said fixture.

11. The voluntary disclosure method of claim 10 in which said fixture is installed for use by passengers in an airport.

12. The voluntary disclosure method of claim 10 in which said fixture is at least one spa fixture from the list of:
a whirlpool bath;
a steam room:
a sauna;
a shower,
said recording or observing means including the inspection of users of said spa fixture by an attendant of said spa facility, said method further including the the step of tracking of the extent of bodily disclosure of users of said spa facility, and the step of tracking costs savings arising from suspiciousness reductions associated with said disclosure, said method also including the step of providing usage of said spa fixture at reduced or zero cost to users, based on said costs savings.

13. A voluntary disclosure device for allowing users to place themselves under reduced suspicion by volunteering to disclose personal information, said voluntary disclosure device comprising:
a voluntary disclosure input for being voluntarily used by some of said users;
a user-specific non-suspiciousness accumulator for being initialized prior to usage of said input by each user of said input;
recording or observing means for recording or observing personal information of at least a portion of users of said input, during usage of said input,
said non-suspiciousness accumulator being incremented through usage of said input.

14. The voluntary disclosure device of claim 13 in which said device is a body scanner for scanning the unclothed body of a user, said input being the disclosure of the naked body to said device.

15. The voluntary disclosure device of claim 13 in which said device is a retinal scanner, said input being the disclosure of the naked eye to said device.

16. The voluntary disclosure device of claim 15, said retinal scanner incorporated into a virtual reality headset for being used in a video game, said disclosure being made in conjunction with the playing of said video game.

17. The voluntary disclosure device of claim 13 in which said device is a fingerprint scanner. said input being the disclosure of the surface of at least one finger to said device.

18. The voluntary disclosure device of claim 17, said fingerprint scanner incorporated into a pushbutton device, said pushbutton device having a concomitant effect in addition to being a fingerprint scanner.

19. The voluntary disclosure device of claim 17, said fingerprint scanner also being for a game, such that a feature of the game is activated by pressing on said fingerprint scanner.

20. The voluntary disclosure device of claim 17 further including a matcher for matching scanned fingerprints with previously stored fingerprints, and an incrementer for awarding non-suspiciousness points in respect to a first time enrolee, and an incrementer for awarding non-suspiciousness points for a second time enrolee, and a detention indicator to indicate that a user should be detained, said selection from among said awarding non-suspiciousness points in respect to a first time enrolee, said awarding non-suspiciousness points for a second time enrolee, and said indicator, being responsive to an output of said matcher.
